(19) United States
(12) Patent Application Publication
(10) Pub. No.: US 2023/0177495 A1
(43) Pub. Date: Jun. 8, 2023

(54) SYSTEMS AND METHODS FOR DIGITAL IDENTITY SCORE

(71) Applicant: ALLSTATE INSURANCE COMPANY, Northbrook, IL (US)

(72) Inventors: Columb Duffy, Derry (GB); Brian Rice, Antrim (GB); Ryan Faulkner, Dungannon (GB); Brennan Gee, Roanoke, VA (US)

(73) Assignee: ALLSTATE INSURANCE COMPANY, Northbrook, IL (US)

(21) Appl. No.: 17/541,959

(22) Filed: Dec. 3, 2021

(51) Int. Cl. G06Q 20/38; G06Q 20/02; G06Q 20/36

(52) U.S. Cl. CPC G06Q 20/38215; G06Q 20/02; G06Q 20/367

(57) ABSTRACT

Methods, computer-readable media, software, and apparatuses may calculate a digital identity score from verifiable credentials from a consumer's digital wallet. The systems and methods may score the consumer's identity based on the type and issuer of the digital credentials or verifiable credentials the consumers holds in the consumer's digital wallet. The systems and methods may issue consumers a digital identity score verifiable credential. The consumers may prove their digital identity score to various digital partners to gain preferential treatment, save time, and save money.

### FIELD OF ART

Aspects of the disclosure generally relate to methods and computer systems, including one or more computers particularly configured and/or executing computer software. More specifically, aspects of this disclosure relate to methods and systems for digital identity.

### BACKGROUND

Currently, there are many digital identity and internet challenges today. First, too many passwords leads to authentication providers brokering authentication and learning behaviors of consumers. Second, digital trust can be one-way with consumers authenticating with a website. This can lead to phishing. Third, there are data quality concerns and high-trust transaction needs (e.g., opening a bank account requiring strong know-your-customer (KYC) information). These concerns and needs may be expensive for in-house experts to prevent fraud and may require external data verification services. Lastly, data centralization may create attractive targets for hackers and provide high risk and expense for enterprises and organizations to protect.

As consumers continue to utilize digital environments and use digital identities, there will be a need to identify a consumer, with high reliability, and there is an opportunity to avoid effort/process duplication by multiple parties by reusing some prior evaluation of the consumer's identity.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable storage media, software, systems, and apparatuses to calculate a digital identity score from verifiable credentials from a consumer's digital wallet.

In some aspects, the system may include at least one processor and a memory unit storing computer-executable instructions. The system may be configured to, in operation, receive, from a digital wallet of a consumer connected to a processor, one or more verifiable credentials from the consumer, wherein the one or more verifiable credentials include one or more elements of identity data. The system may also be configured to, in operation, determine, by the processor, weights of the one or more elements of identity data from the one or more verifiable credentials. The system may also be configured to, in operation, calculate, by the processor, a digital identity score based on one or more elements of identity data and the weighting of the one or more elements of identity data. The system may also be configured to, in operation, send, by the processor, the digital identity score as an identity score verifiable credential to the consumer in the digital wallet.

In other embodiments, the identity score verifiable credential may be encrypted and may require a key to decrypt a plurality of details for the identity score verifiable credential. The system may, in operation, receive validation of the digital identity score by verifying an accuracy of the one or more verifiable credentials. Additionally, the weights of the one or more elements of identity data from the one or more verifiable credentials may be based on one or more of the following: an issuer of each of the one or more verifiable credentials, specific elements from the one or more elements of identity data, or a correlation or contradiction of the various elements of identity data from the one or more verifiable credentials. The system may also be configured to, in operation, scan, by the processor, the one or more verifiable credentials to obtain information needed for an insurance quotation; and automatically generate, by the processor, the insurance quotation with the information from the one or more verifiable credentials. Additionally, the consumer may selectively pick the one or more verifiable credentials and the one or more elements of identity data to be used for calculating the digital identity score. The system may also be configured to, in operation, determine and re-calculate, by a machine learning algorithm executing on the processor, the weights and the digital identity score based on learning trends and historical calculations of digital identity scores.

Of course, the methods and systems of the above-referenced embodiments may also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The present invention is illustrated by way of example and is not limited by the accompanying figures in which like reference numerals indicate similar elements and in which:

FIG. 1 illustrates a block diagram of an exemplary digital identity device that may be used in accordance with one or more aspects described herein;

FIG. 2 illustrates a block diagram of an exemplary digital identity system in accordance with one or more aspects described herein;

FIG. 3 illustrates a conceptual flow diagram for verifiable credentials in an exemplary digital identity system in accordance with one or more aspects described herein;

FIG. 4 illustrates another block diagram of an exemplary digital identity system in accordance with one or more aspects described herein;

FIG. 5 illustrates a block diagram of an exemplary digital identity score system in accordance with one or more aspects described herein;

FIG. 6 illustrates an exemplary method for calculating a digital identity score in accordance with one or more aspects described herein; and

FIGS. 7A and 7B illustrate exemplary user interfaces for use with the digital identity score system in accordance with one or more aspects described herein.

### DETAILED DESCRIPTION

In accordance with various aspects of the disclosure, methods, computer-readable media, software, and apparatuses are disclosed for calculating a digital identity score. The systems and methods may utilize a digital identity to create a digital identity score for consumers. The systems and methods may score the consumer's identity based on the type and issuer of the digital credentials or verifiable credentials the consumer holds in the consumer's digital wallet. The consumer may prove that they hold approved credentials from approved issuers, without revealing the underlying data attributes within the credentials. The systems and methods may issue consumers a digital identity score verifiable credential. The consumers may provide their digital identity score to various digital partners (DPs) to gain preferential treatment, save time, and save money.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

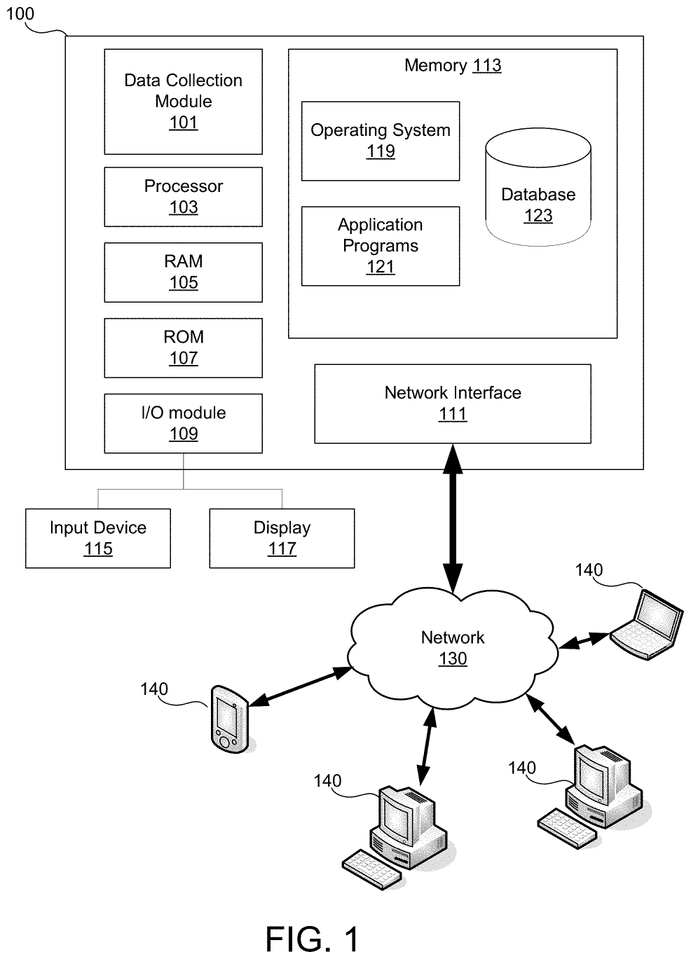

In one or more arrangements, aspects of the present disclosure may be implemented with a computing device. FIG. 1 illustrates a block diagram of an example digital identity device 100 that may be used in accordance with aspects described herein. The digital identity device 100 may be a computing device, such as a personal computer (e.g., a desktop computer), server, laptop computer, notebook, tablet, smartphone, vehicles, home management devices, home security devices, smart appliances, etc. The digital identity device 100 may have a data collection module 101 for retrieving and/or analyzing data as described herein. The data collection module 101 may be implemented with one or more processors and one or more storage units (e.g., databases, RAM, ROM, and other computer-readable media), one or more application specific integrated circuits (ASICs), and/or other hardware components (e.g., resistors, capacitors, power sources, switches, multiplexers, transistors, inverters, etc.). Throughout this disclosure, the data collection module 101 may refer to the software and/or hardware used to implement the data collection module 101. In cases where the data collection module 101 includes one or more processors, such processors may be specially configured to perform the processes disclosed herein. Additionally, or alternatively, the data collection module 101 may include one or more processors configured to execute computer-executable instructions, which may be stored on a storage medium, to perform the processes disclosed herein. In some examples, the digital identity device 100 may include one or more processors 103 in addition to, or instead of, the data collection module 101. The processor(s) 103 may be configured to operate in conjunction with data collection module 101. Both the data collection module 101 and the processor(s) 103 may be capable of controlling operations of the digital identity device 100 and its associated components, including RAM 105, ROM 107, an input/output (I/O) module 109, a network interface 111, and memory 113. For example, the data collection module 101 and processor(s) 103 may each be configured to read/write computer-executable instructions and other values from/to the RAM 105, ROM 107, and memory 113. Processor 103 may include one or more computer processing units (CPUs), graphical processing units (GPUs), and/or other processing units such as a processor adapted to perform computations associated with machine learning and machine learning algorithms.

The I/O module 109 may be configured to be connected to an input device 115, such as a microphone, keypad, keyboard, touchscreen, and/or stylus through which a user of the digital identity device 100 may provide input data. The I/O module 109 may also be configured to be connected to a display device 117, such as a monitor, television, touchscreen, etc., and may include a graphics card. The display device 117 and input device 115 are shown as separate elements from the digital identity device 100; however, they may be within the same structure. On some digital identity devices 100, the input device 115 may be operated by users to interact with the data collection module 101, including providing user information and/or preferences, device information, account information, warning/suggestion messages, etc., as described in further detail below. System administrators may use the input device 115 to make updates to the data collection module 101, such as software updates. Meanwhile, the display device 117 may assist the system administrators and users to confirm/appreciate their inputs.

The memory 113 may be any computer-readable medium for storing computer-executable instructions (e.g., software). The instructions stored within memory 113 may enable the digital identity device 100 to perform various functions. For example, memory 113 may store software used by the digital identity device 100, such as an operating system 119 and application programs 121, and may include an associated database 123.

The network interface 111 may allow the digital identity device 100 to connect to and communicate with a network 130. The network 130 may be any type of network, including a local area network (LAN) and/or a wide area network (WAN), such as the Internet, a cellular network, or a satellite network. Through the network 130, the digital identity device 100 may communicate with one or more other computing devices 140, such as laptops, notebooks, smartphones, tablets, personal computers, servers, vehicles, home management devices, home security devices, smart appliances, etc. The computing devices 140 may also be configured in a similar manner as digital identity device 100. In some embodiments the digital identity device 100 may be connected to the computing devices 140 to form a “cloud” computing environment.

The network interface 111 may connect to the network 130 via communication lines, such as coaxial cable, fiber optic cable, etc., or wirelessly using a cellular backhaul or a wireless standard, such as IEEE 802.11, IEEE 802.15, IEEE 802.16, etc. In some embodiments, the network interface 111 may include a modem. Further, the network interface 111 may use various protocols, including TCP/IP, Ethernet, File Transfer Protocol (FTP), Hypertext Transfer Protocol (HTTP), etc., to communicate with other computing devices 140.

The disclosure is operational with numerous other general purpose and/or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable user electronics, network PCs, minicomputers, mainframe computers, mobile telephones, smart phones, and distributed computing environments that include any of the above systems or devices, and the like.

Aspects of the disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

The following is a list of general definitions that may be known and used in the art for digital identity and/or verifiable credentials.

Verifiable Digital Credential or Verifiable Credential: A digitally signed tamperproof set of data (claims) containing information about a person, entity, or thing, as defined by the World Wide Web Consortium (W3C) Verifiable Credentials Data Model specification.

Decentralized Identifier (DID): A globally unique identifier developed specifically for decentralized systems as defined by the W3C DID specification. DIDs enable interoperable decentralized Digital Identity management. A DID is associated with exactly one DID Document.

DID Document: The machine-readable document to which a DID points as defined by the W3C DID specification. A DID document describes the Public Keys, Service Endpoints, and other metadata associated with a DID. A DID Document is associated with exactly one DID.

Claim: A single piece of information claimed about a person, entity, or thing.

Digital Identity Agent: A software application (agent) that can be used by its owner to issue, hold or verify verifiable digital credentials and securely communicate with other digital identity agents according to well-defined protocols

Digital Wallet: Another name given a digital identity agent, implemented as a mobile app, that belongs to an individual consumer.

Connection: A secure, mutually-authenticated communication channel between two digital wallets

Credential Issuer: An entity (person, organization, business etc.) that issues verifiable digital credentials from their wallet to the holder's wallet. Issuers would normally be an organization that is trusted to some degree and therefore their issued credentials are deemed trustworthy to some degree

Credential Holder: The entity that receives an issued verifiable digital credential. The holder can later share elements of the stored credentials, or create a cryptographic proof that can be used in response to a request, without revealing the underlying data

Credential Verifier: An entity that receives cryptographic proofs or credential elements from a holder. They verify the presented data/proof by checking a public ledger to ensure the digital signatures of the issuer and holder are valid and that the credentials have not been revoked

Proof Request: A request originating from a verifier asking for credentials or a proof from a holder's wallet. In its simplest form it is a request for data, but could also be a request to prove that a person is at least 21 years of age

Cryptographic Proof: This is what the holder presents to the verifier in response to a proof request and is used by the ‘verifier’ to check that signatures are correct, and the credential has not been revoked.

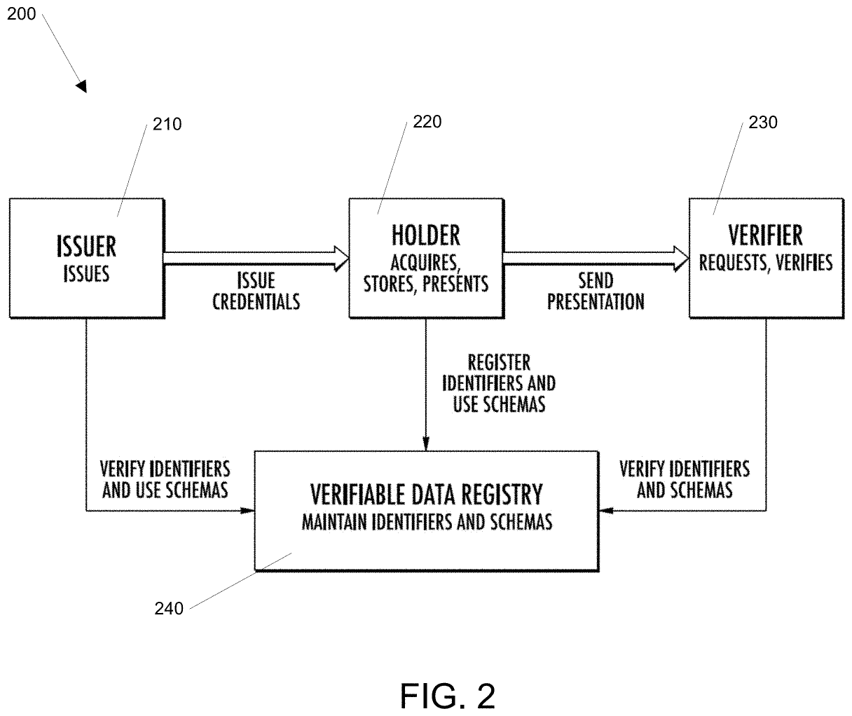

FIG. 2 shows a block diagram 200 of an exemplary digital identity system 200 in accordance with aspects of this invention. The digital identity system 200 illustrated in FIG. 2 is a general representation of a digital identity/verifiable credential system 200 that may be utilized in accordance with aspects of this invention. The digital identity system 200 may provide a standard way to express the physical/paper credentials, such as driving licenses and passports, into cryptographically-secure and machine-verifiable digital credentials. For example, as illustrated in FIG. 2, issuers 210 may create verifiable credentials for the holders 220. The holders 200 may store the verifiable credentials in the holder's digital wallets. The verifiers 230 may ask for proof based upon the verifiable credentials. For example, an issuer 210 may issue a policy credential to a customer (holder) 220. A verifier 230 may ask the customer (holder) 220 to present their new credential as proof. The interaction between the three parties (issuer 210, holder 220, verifier 230) may be referred to as the triangle of trust.

As further illustrated in FIG. 2, verifiers 230 may know with certainty which issuers are attesting to the credential by confirming the associated digital signature against a verifiable data registry 240. The verifiable data registry 240 may verify identifiers from the issuer 210 and use schemas. The verifiable data registry 240 may also register identifiers from the holders 220 and use schemas. The verifiable data registry 240 may also verify identifiers from the verifier 230 and schemas. An exemplary verifiable data registry 240 that may be utilized is Sovrin, where the verifiable data registry 240 may the Sovrin blockchain ledger.

Generally, a schema is a machine-readable file containing a set of attributes that can be used for the claims on a credential. Schemas may be written to the blockchain ledger by the schema author. For example, a schema for creating college transcript credentials may include a definition of attributes such as first name, last name, degree, year, etc. A schema definition may be used by many credential issuers and is a way of achieving standardisation across issuers. For example, a U.S. government authority might register a college transcript schema, then individual colleges might issue college transcript credentials based on this standard schema.

A credential definition defines a verifiable credential that an issuer 210 may issue to an identity holder 220. The credential definition may a machine-readable file containing a definition of a credential which is based on a registered schema (or multiple schemas). The credential definition may be written by the issuer 210 to a blockchain ledger. The credential definition may be specific to an individual issuer 210. The credential definition data structure includes a reference to the instance of the schema(s) on which it is based, plus the public DID of the issuer 210. This approach enables a verifier 230 who receives a proof containing data from a verifiable credential to look up the credential definition on the ledger, obtain its verification key(s), and verify that the issuer 210 has attested to the data.

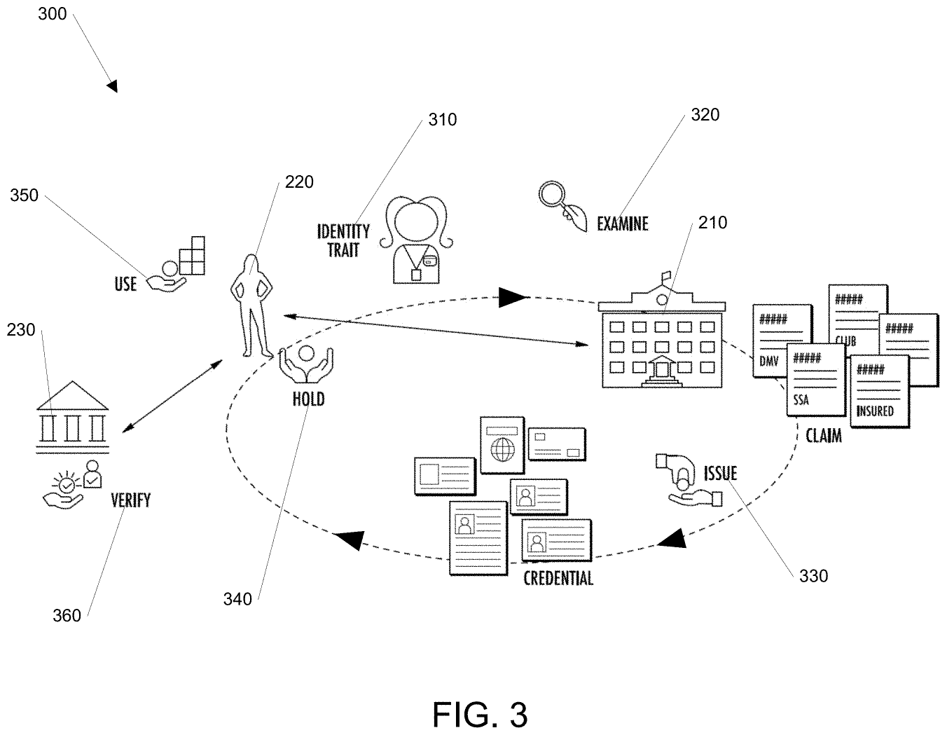

FIG. 3 illustrates a conceptual flow diagram 300 on how verifiable credentialing may occur between issuers 210, holders (users/consumers) 220, and verifiers 230. For example, at block 410, a holder (or user/consumer) 220 may have various identity traits that may be used within the digital identity system 200. Those identity traits may help define and describe the user or consumer 220. The identity traits may include, but not be limited to: physical appearance, job title, name, email address, physical home address, social security number, age, birth place, birth date, address history, job history, college or school degree, graduation date, college or school history, etc. At block 420, an issuer 210 may examine the identity traits from the holder 220. The issuer 210 may perform required vetting, due diligence, regulatory compliance, and other tasks needed to establish confidence in making a claim about an identity trait. At block 430, the issuer 210 may issue a verifiable credential. The issuer 210 may generate and deliver a verifiable credential to the holder 220. The verifiable credential may be comprised of a set of claims in accordance with some predefined schema. At block 440, the holder 220 may hold the verifiable credential. For example, the user, individual, organization, or holder 220 may hold the verifiable credential in a digital wallet. At block 450, the holder 220 may use the verifiable credential. The holder 220 may present one or more verifiable credentials to an entity as proof of identity. At block 460, the verifier 230 may verify the verifiable credential. The verifier 230 may validate the authenticity of the issuer 210 and the holder 220 and then consume/utilize the data from the verifiable credential as required.

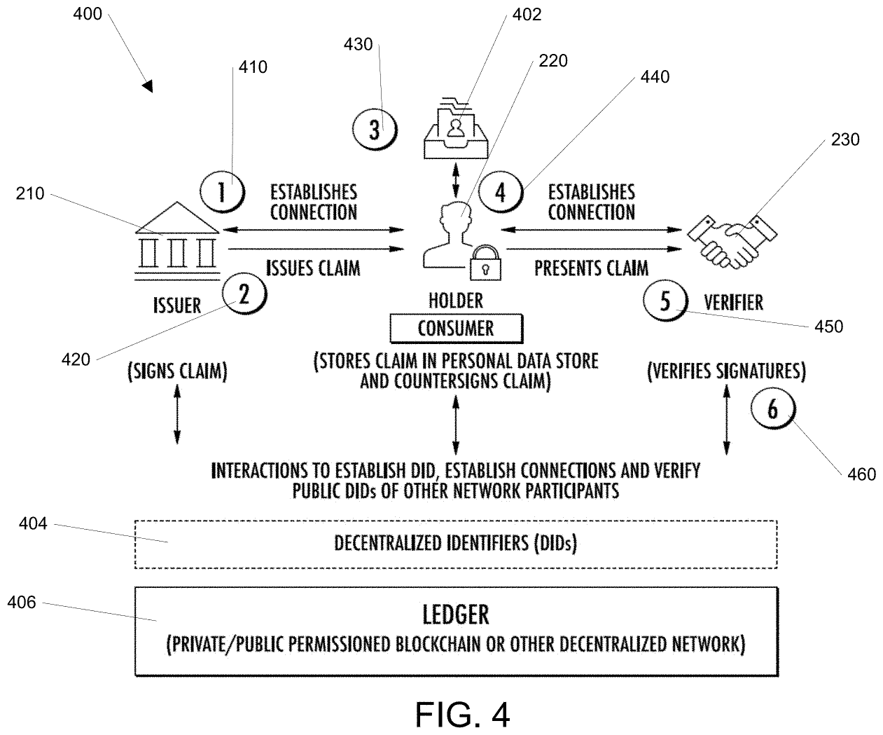

FIG. 4 illustrates a similar block diagram 400 for a digital identity system 200. As illustrated in FIG. 4, the digital identity system 200 may include issuers 210, holders 220, and verifiers 230. The digital identity system 200 may also include a digital wallet 402 associated with the holders 220, decentralized identifiers (DIDs) 404, and a ledger 406. The ledger 406 may be a private or public permissioned blockchain or other decentralized network. At step 410, the issuer 220 and the holder 220 may establish a digital connection. At step 420, the issuer 210 may provide a claim on an identity credential to the identity holder 220. For example, the issuer 210 may sign the credential with a ‘peer DID’ specific to that relationship between the holder 220 and the issuer. At step 430, the holder 220 may maintain the credential in the holder's private digital wallet 402 until the credential must be shared. At step 540, the holder 220 may establish a connection with the verifier (or reliant party) 230 to enable the secure sharing of the identity credentials held in the holder's digital wallet 402. At step 505, the holder 220 may present the claim on the identity credential to the verifier 230 and countersign the claim with the key associated with the private DID 404. At step 506, the verifier 230 may look up the registered DIDs 404 of the issuer 210 to resolve the DID documents. The verifier 230 may also verify the public key of the issuer 210. The issuer DID resolution may be to validate the claim was issued by the issuing authority. The verifier 230 may also determine if the verifiable credential has been revoked through the blockchain-based ledger 406.

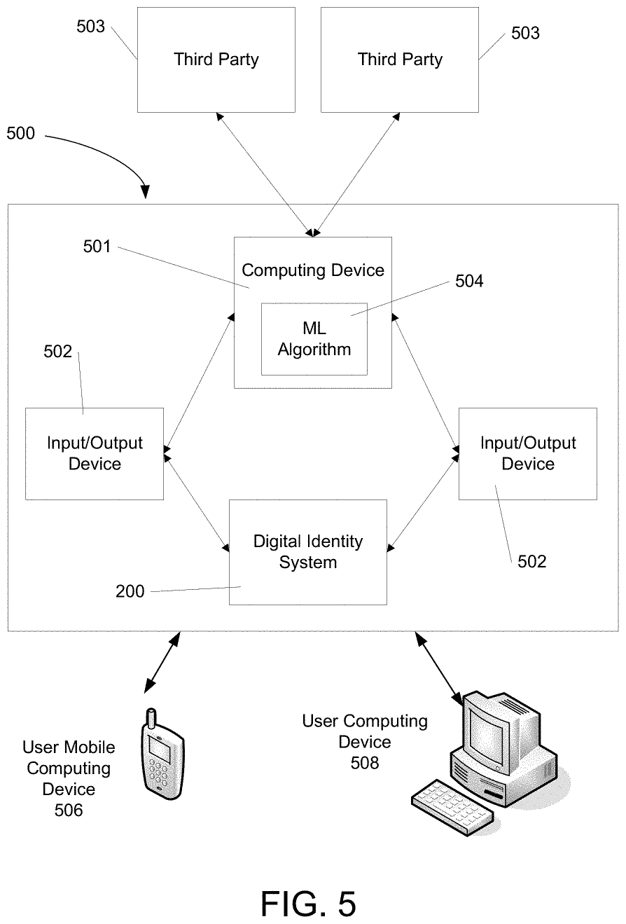

Referring to FIG. 5, an illustrative system 500 for implementing methods for calculating a digital identity score according to the present disclosure is shown. A digital identity score may be similar to a credit score in the sense that a digital identity score system 500 may use various data points to determine the digital identity score, e.g., based upon verifiable credentials (also known as VCs) and other information. The digital identity score may then be issued as a verifiable credential so that when the digital identity score is presented to a third party, the digital identity score can be verified. The identity score VC could be issued by the digital identity score system 500 or enterprise with the digital identity score system 500, based upon information that the consumer provides to use in the assessment and calculation. Once the digital identity score is calculated, the digital identity score system 500 can issue the verifiable credential and/or retain the score to support later requests by a third party (similar to how a credit score works today). The key difference between the credit score and the digital identity score using verifiable credentials is that the digital identity score is an indicator of confidence that the person is who they claim to be, whereas the credit score is an indicator of the consumer's likelihood to make all payments on a loan/credit.

The digital identity score system 500 can provide the ability for a consumer to request a digital identity score. The request for the digital identify score may come from the consumer. The consumer may then provide access to the verified credentials that the consumer choses to be considered in the calculation of the digital identity score. Once the digital identity score system 500 receives those verified credentials, the digital identity score system 500 may assess the consumer's pedigree (the issuer, age, etc.), calculate the digital identity score, and issue that digital identity score in an identity score verifiable credential. The identity score verifiable credential can then be presented by the consumer/holder to a third party (verifier) in the future. The identity score verifiable credential may contain only the score and not any of the data from the verifiable credentials that were utilized in the calculation of the digital identity score. The identity score verifiable credential may be signed by the issuer, like any other verifiable credential that could be proven. A credential (like a packet of data in an envelope) can be issued by an entity (e.g., an insurance company, financial institution, government agency, etc.). The consumer may hold the credential in a software wallet (or digital wallet) and can later present that credential to third party. As described above, there may be three entities involved in decentralized identity: issuers, holders, and verifiers. Through cryptography the credential can be proven or verified to be from the issuer (has a digital signature) and can be proven to have been issued to the holder, thus creating a verified credential.

Over time, the consumer/holder collects numerous verified credentials from all different places, banks, financial institutions, government agencies, merchants etc. Some verified credentials that may be issued by small shops may not be as trustworthy as those issued by large companies such as large merchants, large banks, and government agencies. The digital identity score may be used to verify identity and to understand risk for underwriting purposes, or for any transaction risk the consumer may be entering into with a third party. A higher digital identity score may indicate less risk and more confidence in the known identity of the consumer.

Consumers could provide the digital identity score system 500 different credentials they have in their digital wallet and the digital identity score system 500 could determine a digital identity score for the consumer based on their obtained verified credentials. Consumers may choose to only show some verified credential to determine their score as some verified credentials may not affect the digital identity score. In another embodiment, the digital identity score system 500 may coach users on how to obtain a verified credential from different entities to assist them in improving their digital identity score.

As illustrated in FIG. 5, the digital identity score system 500 may include a digital identity system 200 and/or communicate with the digital identity system 200, a computing device 501, and one or more input/output data 502. Computing device 501 may be a computing device for processing data generated by the digital identity system 200 and calculating a digital identity score based on verifiable credentials from the digital identity system 200. Computing device 501 may receive data from a variety of input/output data 502, including specifically from a digital identity system 200 that provides verifiable credentials. The verifiable credentials may be found in a consumer's digital wallet. Other input/output data 502 may include digital identity system data, verifiable credential data, issuer data, verifier data, and/or other augmentation data from third parties 503.

The digital identity score system 500 and/or the digital identity system 200 may collect information from, and transmit information to, a consumer through various different channels, such as via a user mobile computing device 506, or via a user computing device 508. The user mobile computing device 506 or the user computing device 508 may be similar to the digital identity device 100 described and detailed above with FIG. 1. In some embodiments, the digital identity score system 500 and/or the digital identity system 200 may receive a request from a consumer for a digital identity score and may transmit the request to the digital identity score system 500 and/or the digital identity system 200 identified by the request. For example, a consumer may use a web browser, or other application, on the user mobile computing device 506, or via the user computing device 508 to send a request to the digital identity score system 500 and/or the digital identity system 200. Upon receiving the request, the digital identity score system 500 and/or the digital identity system 200 may initiate calculation of the identity score for the consumer. The computing device 501 may reside either remotely or local to the user mobile computing device 506, or via the user computing device 508. If the computing device 501 resides local to the user mobile computing device 506, or via the user computing device 508, the computing device 501 may be integrated with the user mobile computing device 506, or via the user computing device 508 via an application or other program.

The computing device 501 may possess many of the same hardware/software components as the digital identity device 100 shown in FIG. 1. For instance, the computing device 501 may be used by a program manager and/or insurance provider associated with the item which accompanies the digital identity device 100 to apply various business logic rules, weighting, and algorithms for determining a digital identity score. The program manager may be a separate entity that may oversee implementation and validation of a digital identity score program. Alternatively, the program manager may be one of the service providers already involved in the digital identity score program, including an insurance provider, financial institution, government agency, credit agency, or other service provider. The program manager may be an entity that enables data exchange and transaction processing between all parties involved in a digital identity score program.

Additionally, the computing device 501 may include a machine learning algorithm 504 that may execute or operate on the computing device 501 and/or the digital identity score system 500. The computing device 501 and/or the digital identity score system 500 may utilize the machine learning algorithm 504 for learning trends and improving weighting and digital identity scores from historical determinations. For example, a simple scoreboard approach could potentially penalize consumers if they did not have some data or credentials for a specific category, thereby limiting the maximum potential identity score possible. Using a machine learning approach, we overcome the category model limitations by training the machine learning model to recognize authentic identity claims based on the data that was presented or omitted/unavailable. The machine learning model learns based upon retraining and exposure to new data. After the identity score calculation for a consumer, at a point later in time, the latest model may be used to again score the consumer's identity, thereby providing them a dynamic identity score, that could be reissued to the consumer. The machine learning model may employ federated learning on the consumer's device, and/or centralized learning, and may employ data from multiple other data sources that are available, e.g. identity theft registers, fraud registers or anything else available to the insight scoring system 500. The machine learning algorithm 504 may utilize one or more of a variety of machine learning architectures known and used in the art. These architectures can include, but are not limited to, neural networks (NN), recurrent neural networks (RNN), convolutional neural networks (CNN), transformers, probabilistic neural networks (PNN), linear regression, random forest, decision trees, k-nearest neighbors, support vector machines (SVM), logistical regression, k-means clustering, and/or association rules. RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine learning architectures can be utilized, more specific machine learning architectures when available, and general machine learning architectures at other times can be used. Additionally, the machine learning algorithm 504 may use semi-supervised learning and/or reinforcement learning.

The digital identity system 200 may collect or receive the real-time data from any type of input or output device. The digital identity system 200 and/or the digital identity score system 500 may also be configured to send the data, digital identity score, or verifiable credentials to one or more output devices. For example, the digital identity system 200 and/or the digital identity score system 500 may send the digital identity score and/or the identity score VC to the user mobile computing device 506 or the user computing device 508. Additionally or alternatively, the digital identity system 200 and/or the digital identity score system 500 may be configured to display the digital identity score to the consumer.

The digital identity score and/or the identity score VC may be stored by the computing device 501 or may be sent to a separate processor or server for storing. Alternatively, the digital identity score and/or the identity score VC may be stored in the memory of an input/output device. In at least one embodiment, the digital identity score and/or the identity score VC may be stored in a portable device and transferred from the portable device to another device. For example, the digital identity score and/or the identity score VC may be stored in the user mobile computing device 506 and transferred to a device, such as a computer, at a third party wanting to verify the consumer's identity.

The computing device 501, the digital identity system 200, and/or the digital identity score system 500 may be configured to collect and receive input/output data 502 relating to a consumer's identity, most likely through verifiable credentials. The verifiable credentials may be found in a consumer's digital wallet. The verifiable credentials may include one or more of the following data: physical appearance, job title, name, email address, physical home address, social security number, age, birthplace, birth date, address history, employment information, employment history, college or school degree, graduation date, college or school history, utilities, financial information, home ownership, employment information, etc. This list is not exhaustive. Other data may be included with the verifiable credentials that can provide and describe the identity of a consumer. Other input/output data 502 may include digital identity system data, verifiable credential data, issuer data, verifier data, and/or other augmentation data from the third parties 503.

The computing device 501 may calculate the digital identity score in any suitable manner. For example, the computing device 501 may collectively include all of the verifiable credentials available to the computing device 501 for calculating the digital identity score. Additionally, the computing device 501 may apply weights to any of the collected or received verifiable credentials described above. There may be various categories for weighting in calculating the digital identity score, such as who issued the verifiable credential, what information is available in the verifiable credential, and does the information in the verifiable credential correlate or contradict other information in other verifiable credentials. All of this information may be utilized to weight or rank the verifiable credentials used with the calculation of the digital identity score.

What matters to weighting and calculating the digital identity score is 1) who issued the verifiable credential and 2) what is the information in the verifiable credential and the existence/nature of the relationship between the issuer and the holder that justifies the issuance of the verifiable credential, and 3) does the data/information in the verifiable credentials correlate or contradict. The issuer that issues the verifiable credential may affect how the digital identity score is scored, for example, a large bank, government agency, or large merchant is more trustable then a small shop issuing a verifiable credential.

Additionally, the nature of issuer and what business they are in may affect how much weight the verifiable credential is given. Lastly, if information/data in the verifiable credentials correlate, the digital identity score may be higher. Conversely, if there is contradicting information and data in the verifiable credentials, the digital identity score may be lower.

For example, some verifiable credentials issued by companies may be worth more weight for determining the digital identity score (large credit card companies, large financial institutions, government agencies, and/or utility companies can associate you with an existing address). In comparison, some verifiable credentials may not be useful in determining identity score (such as a small merchant or an address from a merchant that is easy to change and not a verifiable home address). Additionally, verifiable credentials from regulated industries and/or companies may be weighted higher than verifiable credentials from unregulated industries. Further, verifiable credentials from government agencies may be weighted high.

In another example, a utility company verifiable credential that includes an address or home address may be valuable and thus weighted high—as this address can be verified with a high degree of confidence. In comparison, an on-line order merchant verifiable credential that includes an address or home address may not be as valuable and thus be weighted low—as this address can be changed easily by the consumer.

Additionally, in another example, the information/data from one order from a merchant verifiable credential may not be as valuable as consistent information/data from a history of orders from the same merchant verifiable credentials.

In some embodiments, the computing device 501 and/or the digital identity score system 500 may utilize categories to calculate and determine the digital identity score. For example, the computing device 501 and/or the digital identity score system 500 may use a set number of verifiable credentials from different categories to determine digital identity score. The categories may be retail, government, banking, utility, etc. By utilizing different categories, the total digital identity score may be based on different verifiable credentials from different category sources. A “pedigree” or standing of the company/organization in the industry may also be used in the weighting for the information/data in the verifiable credential.

The digital identity score may be any type of value, such as a numerical or alphabetical value. For example, the digital identity score may be a number between 0 and 800, similar to a credit score, or a score between 0 and 1000, or a score between 0 and 1.0, a letter grade, such as A, B, C, D, or F, with plus/minus gradients. The digital identity score may also be a range in some embodiments.

After the digital identity score is calculated and determined, the computing device 501 and/or the digital identity score system 500 may present the digital identity score to the consumer as an identity score verifiable credential, or a reusable identity score verifiable credential regarding the consumer's identity. The identity score verifiable credential may include the digital identity score and a summary of the score. The details of the identity score verifiable credential may be encrypted. A key may be purchased or used to unlock and decrypt to show the details of the identity score verifiable credential.

The consumer can present this identity score verifiable credential to any third parties as proof of who the consumer is. The identity score verifiable credential provides the third party proof of identity—trust it is you. The identity score verifiable credential may be held in the digital wallet of the consumer with all of the consumer's other verifiable credentials. The identity score verifiable credential may include a time stamp of when it was issued. The identity score verifiable credential may also include an expiration date.

The identity score verifiable credential may also be revoked. The standard mechanism for revoking verifiable credentials may be employed for the identity score verifiable credential. For example, a revocation notice may be added to a publicly accessible shared ledger indicating that the identity score verifiable credential has been revoked. During the verification process, the revocation may follow and may be attached to the presentation of the identity score verifiable credential. A verifier may then check a revocation ledger to determine whether the identity score verifiable credential is still valid.

Third parties who receive an identity score verifiable credential containing unencrypted data and an encrypted data set may be able to see the score and summary in the unencrypted data portion. If a third party wants to see further details contained in the encrypted portion of the identity score verifiable credential, the third party may purchase a key to decrypt the encrypted data portion in the identity score verifiable credential. The details may include how the digital score was calculated, the weighting that was used, details from the verifiable credentials, etc.

In some embodiments, the consumer selects what verifiable credentials will be used for the digital identity score. The consumer may provide guidelines, rules, or exclusions for the digital identity score calculation. For example, the consumer may provide a rule stating: do not use any bank verifiable credentials for the calculation of the digital identity score, or do not use a certain merchant's verifiable credentials for the calculation of the digital identity score.

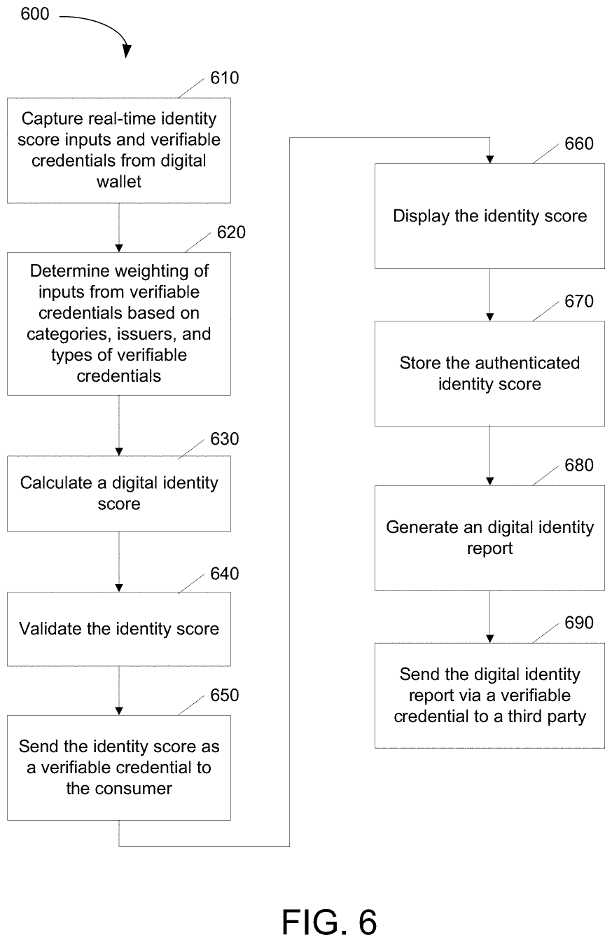

The steps that follow may be implemented by one or more of the components in FIGS. 1-5 and/or other components, including other computing devices. FIG. 6 illustrates a method 600 of calculating and utilizing a digital identity score according to one or more aspects of the invention. As illustrated in step 610, the computing device 501 and/or the digital identity score system 500 may capture real-time identity score inputs and verifiable credentials from a digital wallet of a consumer, as discussed in detail above. In step 620, the computing device 501 and/or the digital identity score system 500 may determine weighting of inputs from verifiable credentials based on categories, issuers, and types of verifiable credentials.

In step 630, the computing device 501 and/or the digital identity score system 500 calculates or generates a digital identity score for the consumer, as discussed in detail above. The digital identity score may be based at least in part on the real-time identity score inputs and the data/information in the verifiable credentials presented from the consumer. In step 640, the calculated digital identity score may be validated. The digital identity score may be validated by a validating entity or by the entity that oversees the calculation/generation of the digital identity score. The digital identity score may be validated by verifying the verifiable credentials in the digital wallet. The digital identity score may be any numerical, alphabetical, or graphical value.

In step 650, the digital identity score may be sent to the consumer and/or a third party as an identity score verifiable credential. For example, the digital identity score may be sent to a computing device, the consumer, or a third party, such as an insurance company, merchant, financial institution, or governmental agency. The digital identity score may also be displayed, as illustrated in step 660. The digital identity score may be displayed on any type of device. For example, the digital identity score may be displayed on a computing device or mobile device.

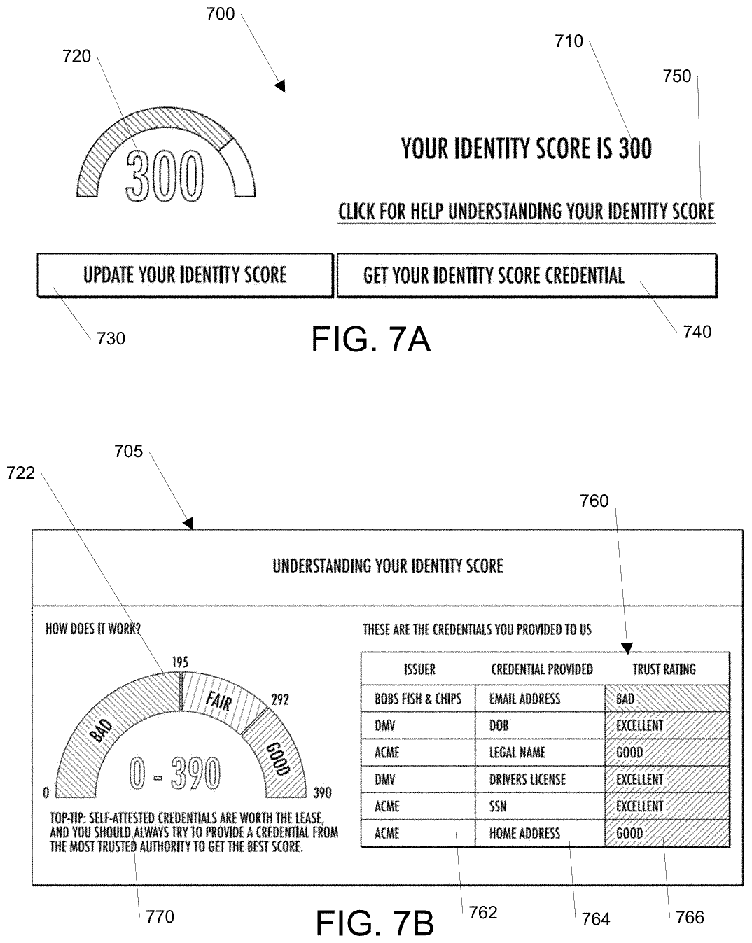

FIGS. 7A and 7B illustrates an example user interface 700, 705, as may be output for display to the consumer, presenting the digital identity score. In some examples, user interface 700, 705 may be displayed by user computing device 508, or user mobile computing device 506. It should be understood that the user interface of FIGS. 7A and 7B is designed to illustrate various features and aspects of the user interfaces and the system, and not to limit the visual appearance or layout of the user interface.

FIG. 7A shows an exemplary user interface 700 of the digital identity score to the consumer. As illustrated in FIG. 7A, the user interface 700 may include the digital identity score 710, a score wheel 720 showing how the digital identity score compares to other digital identity scores, an “UPDATE” digital identity score button 730, a “GET YOUR IDENTITY SCORE CREDENTIAL” button 740 (for receiving the identity score verifiable credential), and a “HELP UNDERSTANDING” link 750.

FIG. 7B shows another exemplary user interface 705 of the digital identity score to the consumer. As illustrated in FIG. 7B, the user interface 705 may be presented to the consumer when the consumer clicks on the “HELP UNDERSTANDING” link 750 from the user interface 700 illustrated in FIG. 7A. The user interface 705 may include a more detailed digital identity score wheel 722. Additionally, the user interface 705 may include a credential table or a listing 760 of the credentials that were presented to the computing device 501 and/or digital identity score system 500 by the consumer. The credential table 760 may include a listing of the issuer 762, the type of credential provided 764, and the trust rating 766 of that specific issuer/type of credential. The user interface 705 may also include a “TOOL TIP” 770 that provides the consumer recommendations or tips on how to improve the digital identity score.

In some embodiments, colors may be used on the user interface 700, 705 to represent the positive or negative correlation to the digital identity score or trust rating, in order to help the consumer quickly understand their digital identity score. For example, a low digital identity score or low trust rating might be displayed with a red color while a high digital identity score or high trust rating may be displayed with a green color. In some embodiments, a degree of shading or hatching may correspond to a degree of high/low digital identity score/trust rating.

As illustrated in step 670, the digital identity score may be stored. The digital identity score may be stored on any type of device including memory. For example, the computing device 501 and/or digital identity device 100 may store in the digital identity score.

As illustrated in step 680, the computing device 501 and/or the digital identity score system 500 may generate a digital identity score report for the consumer and/or a third party. The digital identity report may contain any type of information. For example, the digital identity report may contain the digital identity score and the digital identity summary as an unencrypted report. The digital identity report may also include an encrypted portion containing additional information, such as information regarding the calculation of the digital identity score and or the potential changes to the digital identity score based on the information within the digital identity report, as discussed above. A key would be required to unencrypt the encrypted portion of the report. As illustrated in step 690, the digital identity report may be issued to the holder in the form of a VC, and then further presented by the issuer to third parties. When a third party (a verifier) receives the presented VC from the issuer, the third party may request a key to unencrypt the encrypted portion of the report contained in the VC.

In some embodiments, the consumers could request the digital identity score to be updated. In another embodiment, a mobile phone application may detect that a new verifiable credential has been issued and ask the consumer if they would like to request an updated digital identity score based on the new credential and/or the new credential being issued. The digital identity score system 500 may ask the consumer permission to update the digital identity score on some frequency. Additionally, the digital identity score may be time limited, so the consumer may need to update the digital identity score on some frequency.

In some embodiments, the digital identity score may contain or include zero knowledge proof, which means that the consumer does not have to show actual credentials to actually prove you. In some embodiments, the digital identity score may use zero-knowledge proofs instead of or as well as data contained in a verifiable credential. These zero-knowledge proofs may protect consumer data privacy and simultaneously allow certain facts to be determined. The zero-knowledge proofs may utilize the fact that there is a verifiable credential issued by various issuers in the possession of the consumer. Cryptography may be used to prove the consumer's identity. The consumer does not have to actually share raw data, but can show proof that the consumer has the data and the data has been verified. In some embodiments, the verifiable credentials and/or identity score may be used for a method for facilitating presentation by a consumer of data required for a transaction with an organization. The verifiable credentials and/or identity scores may be used for the organization to better understand risk associated with the data prior to establishing a transaction with the customers.

For example, any organization transacting with a consumer typically requires a consumer to provide data about themselves, and this is typically provided over the Internet by the consumer using a keyboard or voice mechanism (e.g., typing their name, address, ZIP code, email address, etc. into a web form, or using voice-to-text capabilities to achieve the same data entry.) These approaches may be prone to typographical errors, non-standard abbreviations, and other inaccuracies. Organizations receiving these data often perform validation checks to determine reliability of the data, and accept risk that errors or inaccuracies may remain.

The proposed method is to use data issued to the consumer by third parties in the form of verifiable credentials and/or identity scores as a source of data, to avoid the issues and risks associated with typical data presentation methods. When the consumer is requested to provide data to the transacting organization, instead of presenting a web form or similar input option, the transacting organization may request permission to connect with the consumer's digital wallet in which their verifiable credentials are stored. Note that this is an existing capability of the De-centralised Identity Communications (DID Comm) protocol, as is the ability to selectively disclose data. This DID Comm protocol and connection with the consumer's digital wallet can be employed to retrieve data that is contained in a plurality of verifiable credentials for the purposes of transacting with the organization (making the request to the consumer's digital wallet for the data required to establish the transaction, presenting the data using the ‘selective disclosure’ capability of DID Comm, etc.). Employing this method to receive data from the consumer allows the transacting organization to better determine trust in the data presented because the method avoids typographical error, non-standard data formats, and the transacting organization can use the identity of the issuing organization(s) of the verifiable credential(s) to determine the level of risk associated with the data presented. The combination of presentation of data via verifiable credentials stored in digital wallet(s) and knowing the identity of the verifiable credential issuing organization enables the transacting organization to better evaluate the risk inherent in the data presented and use that to inform decision on how to establish the transaction.

One-Click Quote

In some embodiments, a user's mobile application may scan the verifiable credential and/or identity score to obtain information needed to get an insurance quote. The verifiable credential(s) and/or identity score may be utilized to obtain information needed for other business transactions as well. The insurance quote may be partially filled or fully generated based on the review of the verifiable credentials and/or identity score. Generally, a consumer wants to obtain an auto insurance or property insurance quote but does not want to fill out all the paperwork asking for information needed by the insurance company.

To solve this problem, the digital identity system 200 may ask for and/or provide particular types of verifiable credentials and/or an identity score from the user to be able to obtain the information needed for the insurance quote. A consumer can collect digital verifiable credentials from numerous digital partners throughout their digital lifetime. A consumer may obtain an insurance quote (or other financial quotation or application) by sharing proof of the required data from the consumer's digital wallet, which has been attested to by approved entities and/or verifiers. The digital identity system 200 can verify the data provided by the consumer by looking up the ledger to obtain the required cryptographic keys to perform the verification.

The user's mobile application may scan a consumer's verifiable credentials to obtain information needed to get an insurance quote (such as property address, users name, date of birth or age or age range, vehicle type, etc.). The digital identity system 200 may ask the consumer if the required data selected from the verifiable credentials and/or identity score may be forwarded to an insurance company to get a quote. The quote may be generated based on the received verifiable credentials and/or identity score. The digital identity system 200 may determine if all the information needed for quote is found in a consumer's verifiable credentials. If not all of the information has been provided via the consumer's verifiable credentials, the digital identity system 200 may generate questions to the consumer to obtain missing information. The digital identity system 200 may prompt the consumer for information via a secure communication channel. The digital identity system 200 may determine if other information found in the consumer's verifiable credentials may be used in place of missing information.

In some embodiments, the digital identity system 200 and/or the digital identity score system 500 addresses many of the internet Identity challenges. The following provides various Internet challenges that may be addressed by digital identity scores, verifiable credentials, digital identity, and trust.

The first Internet challenge may be user IDs/passwords, which can be susceptible to attack. They may not be a solid basis for trust and work only one way. Digital identity scores, verifiable credentials, digital identity, and trust may address this challenge. Websites can use DIDs and, as needed, verifiable credentials to get enough information about consumers to establish sessions and is a lot easier and safer for consumers than passwords. Digital Wallets used by individuals and online services exchange at least DIDs, and often verifiable credentials, to reliably identify one another as peers each time they connect.

The next Internet challenge may be that personal information and identifiers are not trusted because it is impossible to tell if the data was actually issued to the person providing it. The many breaches of private identifiers make them impossible to completely trust, and verifying that information adds (sometimes significant) costs. Digital identity scores, verifiable credentials, digital identity, and trust may address this challenge. Presentations of claims from verifiable credentials and knowing who issued the credentials mean that the claims can be trusted to be correct. When collecting information from consumers, services can use their digital wallet agent to connect with, request, and receive back proofs of claims from a consumer's digital wallet agent.

The next Internet challenge may be that we often must resort to in-person delivery of paper documents to prove things about ourselves, a further cost for all participants. Digital identity scores, verifiable credentials, digital identity, and trust may address this challenge. We can use verifiable credentials online instead of having to use paper documents in-person.

The next Internet challenge may be that reviewers of the paper documents we present must become experts in the state of the art in forging and falsifying paper documents. With digital identity however, the trust of the digital claims is in cryptography and knowing about the issuer. People do not have to be experts at detecting forgeries.

The next Internet challenge may be the identifiers we use are correlated across sites, allowing inferences to be made about us, and exposing information we do not intend to be shared across sites. By using private DIDs and verifiable credentials based on Zero Knowledge Proofs (ZKP) however, we can radically reduce the online correlation that is happening today.

The next Internet challenge may be that centralized repositories of identifiers and data about the people associated with those identifiers are targeted by hackers because the data has high value. With digital identity however, high value data can be accepted only when presented as a claim from a verifiable credential, thereby removing the need to retain data, and reducing risk of attack and having data from breaches.

The next Internet challenge may be that centralized identifiers can be abused by those who control those identifiers. For example, they can be taken away from a subject without due process. How digital identity scores, verifiable credentials, digital identity and trust may address this challenge: You create your own DIDs and those identifiers cannot be taken away by a centralized authority. You control your DIDs, no one else.

In some embodiments, the digital identity system 200 and/or the digital identity score system 500 may provide various other benefits. For example, the digital identity system 200 and/or the digital identity score system 500 may provide monetization for the identity score credential issuance. The digital identity system 200 and/or the digital identity score system 500 may also provide benefits from partnerships with approved digital partners (DPs). For example, the digital identity system 200 and/or the digital identity score system 500 may provide incentivized advertisements directing consumers from DP consumer channels. The digital identity system 200 and/or the digital identity score system 500 may enhance brand in identity protection. The digital identity system 200 and/or the digital identity score system 500 may also provide benefits for the protection of business as the identity score could be an indicator of a consumer's risk. Additionally, the digital identity score may provide privacy to the consumer with the ability to get a digital identity score without sharing personal data. The digital identity score may also provide a consumer with preferential treatment with DPs. For example, the digital identity score may provide the consumer with preferential rates on services, such as loans, accommodation rentals, car rentals, etc. Further, the digital identity score may provide benefits to digital partners as verifiers, such as reducing risk of identity fraud, and enabling less rigorous KYC processes leading to faster onboarding of new customers. The digital identity score may also provide benefits to digital partners as issuers, such as monetization of credential issuance, a competitive advantage because consumers will want to get high scoring identity credentials, and access to a digital-identity-enabled pool of customers.

In some embodiments, the one-click quote may provide various benefits. For example, the one-click quote may provide high quality incoming consumer data, attested to by the digital identity system 200 and/or the digital identity score system 500 approved entities. The one-click quote may also reduce costs for obtaining quote prefill data from 3^{rd} parties. The one-click quote may also provide the ability to use zero knowledge proofs (ZKP) to reduce the amount of customer personal data being processed and stored. The one-click quote may also provide benefits for the consumers, such as: streamlined quote experience with no form filling; reduce incorrect quotes due to user input errors; ability to proof facts without revealing personal data (e.g., age over 21 without revealing date of birth); eliminating the need to send physical documents or emailing copies when requesting a quote; and ability to share only specific data attributes from a digital credential without revealing the entire credential (selective disclosure). Further, the one-click quote may provide benefits to digital partners and issuers, such as: competitive advantage over other digital partners; reduced customer personal data storage; monetized credential issuance; increased customer base through participating in the digital identity ecosystem; and reduced fraud by mitigating fake credentials claiming to be from the digital partner.

Aspects of the invention have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. An apparatus, comprising:
a processor;
a memory unit storing computer-executable instructions, which when executed by the processor, cause the apparatus to:
receive, from a digital wallet of a consumer connected to the processor, one or more verifiable credentials from the consumer, wherein the one or more verifiable credentials include one or more elements of identity data;
determine, by the processor, weights of the one or more elements of identity data from the one or more verifiable credentials;
calculate, by the processor, a digital identity score based on one or more elements of identity data and the weighting of the one or more elements of identity data; and
send, by the processor, the digital identity score as an identity score verifiable credential to the consumer in the digital wallet.

2. The apparatus of claim 1, wherein the identity score verifiable credential is encrypted and requires a key to decrypt a plurality of details for the identity score verifiable credential.

3. The apparatus of claim 1, wherein the computer-executable instructions, when executed by the processor, further cause the apparatus to:
receive validation of the digital identity score by verifying an accuracy of the one or more verifiable credentials.

4. The apparatus of claim 1, wherein the weights of the one or more elements of identity data from the one or more verifiable credentials is based on one or more of the following: an issuer of each of the one or more verifiable credentials, specific elements from the one or more elements of identity data, or a correlation or contradiction of the various elements of identity data from the one or more verifiable credentials.

5. The apparatus of claim 1, wherein the computer-executable instructions, when executed by the processor, further cause the apparatus to:
scan, by the processor, the one or more verifiable credentials to obtain information needed for an insurance quotation; and
automatically generate, by the processor, the insurance quotation with the information from the one or more verifiable credentials.

6. The apparatus of claim 1, wherein the consumer selectively picks the one or more verifiable credentials and the one or more elements of identity data to be used for calculating the digital identity score.

7. The apparatus of claim 1, wherein the computer-executable instructions, when executed by the processor, further cause the apparatus to:
determine, by the processor, the weights via a machine learning algorithm trained to recognize authentic identity claims based on data associated with the one or more verifiable credentials that were presented or omitted.

8. A method comprising:
receiving, from a digital wallet of a consumer connected to a processor, one or more verifiable credentials from the consumer, wherein the one or more verifiable credentials include one or more elements of identity data;
determining, by the processor, weights of the one or more elements of identity data from the one or more verifiable credentials;
calculating, by the processor, a digital identity score based on one or more elements of identity data and the weighting of the one or more elements of identity data; and
sending, by the processor, the digital identity score as an identity score verifiable credential to the consumer in the digital wallet.

9. The method of claim 8, wherein the identity score verifiable credential is encrypted and requires a key to decrypt a plurality of details for the identity score verifiable credential.

10. The method of claim 8, further comprising:
receiving validation of the digital identity score by verifying an accuracy of the one or more verifiable credentials.

11. The method of claim 8, wherein the weights of the one or more elements of identity data from the one or more verifiable credentials is based on one or more of the following: an issuer of each of the one or more verifiable credentials, specific elements from the one or more elements of identity data, or a correlation or contradiction of the various elements of identity data from the one or more verifiable credentials.

12. The method of claim 8, further comprising:
scanning, by the processor, the one or more verifiable credentials to obtain information needed for an insurance quotation; and
automatically generating, by the processor, the insurance quotation with the information from the one or more verifiable credentials.

13. The method of claim 8, wherein the consumer selectively picks the one or more verifiable credentials and the one or more elements of identity data to be used for calculating the digital identity score.

14. The method of claim 8, wherein the calculating, by the processor, includes calculating via a machine learning algorithm the digital identity score based on learning trends and historical calculations of digital identity scores.

15. One or more non-transitory computer-readable media storing instructions that, when executed by a computing device, cause the computing device to:
receive, from a digital wallet of a consumer connected to a processor, one or more verifiable credentials from the consumer, wherein the one or more verifiable credentials include one or more elements of identity data;
determine, by the processor, weights of the one or more elements of identity data from the one or more verifiable credentials;
calculate, by the processor, a digital identity score based on one or more elements of identity data and the weighting of the one or more elements of identity data; and
send, by the processor, the digital identity score as an identity score verifiable credential to the consumer in the digital wallet.

16. The one or more non-transitory computer-readable media of claim 15, wherein the identity score verifiable credential is encrypted and requires a key to decrypt a plurality of details for the identity score verifiable credential.

17. The one or more non-transitory computer-readable media of claim 15, wherein the weights of the one or more elements of identity data from the one or more verifiable credentials is based on one or more of the following: an issuer of each of the one or more verifiable credentials, specific elements from the one or more elements of identity data, or a correlation or contradiction of the various elements of identity data from the one or more verifiable credentials.

18. The one or more non-transitory computer-readable media of claim 15, storing further instructions that, when executed by the computing device, cause the computing device to:
scan, by the processor, the one or more verifiable credentials to obtain information needed for an insurance quotation; and
automatically generate, by the processor, the insurance quotation with the information from the one or more verifiable credentials.

19. The one or more non-transitory computer-readable media of claim 15, wherein the consumer selectively picks the one or more verifiable credentials and the one or more elements of identity data to be used for calculating the digital identity score.

20. The one or more non-transitory computer-readable media of claim 15, storing further instructions that, when executed by the computing device, cause the computing device to:
determine and re-calculate, by a machine learning algorithm executing on the processor, the weights and the digital identity score based on learning trends and historical calculations of digital identity scores.
